(19) United States
(12) Patent Application Publication
(10) Pub. No.: US 2003/0221012 A1
(43) Pub. Date: Nov. 27, 2003

(54) Resource manager system and method for access control to physical resources in an application hosting environment

(75) Inventors: Christian Herrmann, Rangendingen (DE); Harry Hoff, Gaertringen (DE)

Correspondence Address: Gerald R. Woods, IBM Corporation, T81/503, PO Box 12195, Research Triangle Park, NC, 27709, US

(73) Assignee: International Business Machines Corporation, Armonk, NY

(21) Appl. No.: 10/443,279

(22) Filed: May 22, 2003

(30) Foreign Application Priority Data
May 22, 2002 (DE) 2011237.100000000

(51) Int. Cl. G06F 15/16

(52) U.S. Cl. 709/229; 713/201

(57) ABSTRACT

A resource system and method for controlling access to physical resources in an application hosting environment is based on a five dimensional resource and security model which extends the existing three-dimensional security model by adding logical resource (LR) and organization unit (OU) dimensions. The logical resources are an abstraction of physical resources. Organization units (OU) represent a set of logical resources without access attributes, a set of physical resources and a function which maps logical to physical resources for defined organizational entities. The implementation separates the physical system dependent resources from the components and access control using the resources.

### FIELD OF THE INVENTION

The present invention relates in general to a client-server environment, and more particularly to a resource manager system and method for controlling access to physical resources provided or accessible by applications at the server side in an application hosting environment. Background of the Invention

### BACKGROUND OF THE INVENTION

In a traditional client-server model, a great number of clients have access to a central server which provides host applications. These applications are used by clients connected via network to the server either directly or via a proxy server. The clients run on workstations and send requests to the host applications to perform specific processing. To perform the processing, the host applications use physical resources on the server system (files, tables, keys, queues, communication links etc). The clients are assigned to specific units (e.g. companies, departments in a company, functional groups in a department etc). The resource manager at the host system controls the access to the host resources by using definitions in its configuration and security database.

A prior art access model commonly used in such a client-server environment is called the three-dimensional access model (see FIG. 1). It consists of a set of physical resources as the first dimension, a set of roles as the second dimension, and a set of users and/or user groups as the third dimension.

A role represents a set of activities and tasks required to fulfil a specific type of work. To support these activities and tasks, a set of physical resources is needed. The term physical resource as defined in the present invention is an object that may be used by an application for execution of a specific process, e.g. a signature key for authentication purposes, a printer for printing documents, a database table or a file for storing data, etc. The physical resource may be part of the application itself or a separate component accessible via the application.

Resources are assigned to roles. Users and/or user groups are granted access rights to these roles. This separates a user from the resource by inserting a role layer. Thus the origin for the access is no longer a user but a role. This makes it easy to add or delete users. A typical prior art implementation of the 3-dimensional access model in such a client-server environment is illustrated by FIGS. 2A-2E. A user (client OU1) logs on to a host application on the server system by entering a user ID and password. Then, the user performs the desired processing by sending a request to the host application. This request contains two physical resources the user wants to access (e.g. sign a message with a key ‘SIGN_KEY_OU1’ and put it on a message queue ‘SEND_QUEUE_OU1’; see FIG. 2A.). The request is sent via the network to the connected host application (see FIG. 2B). The host application receives the request, retrieves the provided data, creates the appropriate requests for the resource manager and sends them to it (“read the sign key” and “put the message on a queue” (see FIG. 2C). The resource manager first checks the access rights for the requesting user ID. Therefore it uses the definitions of roles and users in its security database. It checks whether the physical resources with the requested access are in any role assigned to the requesting user ID. If any role contains the requested resources with the requested access, access is permitted. In this sample, the application first wants to retrieve a sign key. After successfully signing the message, it wants to put this signed message on a specific message queue (see FIG. 2D). If access is permitted, the resource manager performs the requested access (e.g. it first reads the sign key ‘SIGN_KEY_OU1’ and, with a second request, it puts the signed message on a physical message queue ‘SEND_QUEUE_OU1’). After completion it returns the result to the requesting application and the application returns it to the client.

The same user now may log on to the same host application for another organizational unit. The user may perform the same request, but the physical sign key and the physical message queue may be completely different. The user would specify another physical resources with the request. The role would either be a different one containing the physical resources for OU2 or it would be the same which contains the physical resources for both OUs, OU1 and OU2 (see FIG. 2E).

Resource access control plays a very important role in an application hosting environment. Application hosting takes advantage of the Internet and economies of scale for delivery of e-business applications.

A vendor acting as an Application Service Provider (ASP) installs and maintains other companies' business applications at one or more of its professionally managed data centers (server). The employees of the company (clients/user) can then access applications over the Internet.

In contrast to the traditional client-server model of implementing and maintaining application entirely at companies own facilities, the application hosting model lets the company run distributed applications without incurring the capital or personnel overhead of a complex computer infrastructure.

In such hosting scenario the ASP provides application hosting services for many companies concurrently by using resource access control based on the three-dimensional security model described above.

A disadvantage of using the three-dimensional security model especially in the hosting environment is that current resource manager must define separate roles for each organization unit independent of the fact the roles themselves represent the same functionality. These roles contain the physical resources. Some different physical resources are used in different role definitions. Changing of resources makes it necessary for the administrator to know which roles are affected by the resource change. The administrator must change the roles and adjust the configuration data, taking care to preserve data integrity and consistency. This may be very time consuming where large amounts of data are involved or the data changes frequently.

It is an object of the present invention to provide a system and method for access control to resources in a client-server environment that avoids the disadvantages of prior art systems.

### SUMMARY OF THE INVENTION

The present invention discloses an resource manager and method for access control to physical resources in a client-server system which is based on a five dimensional resource and security model that extends the existing three-dimensional security model by adding logical resources (LR) and organization units (OU) dimensions. The logical resources represent an abstraction of the physical resources, and the organization units (OU) represent a set of logical resources without access attributes, a set of physical resources and a function that maps logical to physical resources to organizational entities. The implementation of a logical resource layer allows separation of the physical system dependent resources from the components and access control using the resources. This creates abstract configuration and process modelling that is independent from the physical structure of the system and that strongly reduces the administrative work required on the client side as well the server side.

### BRIEF DESCRIPTION OF THE DRAWINGS

The present invention will be described in more detail with the accompanying drawings in which:

FIG. 1 shows the prior three-dimensional resource and security model;

FIGS. 2A-2E shows resource access control in a client-server architecture using the prior art three-dimensional security model;

FIG. 3A shows the three-dimensional resource model;

FIG. 3B shows the three-dimensional security model which is extended to a five-dimensional resource and security model by the present invention;

FIG. 3C shows building of an intersection between the sets of logical resources of the OU (Organizational Unit) and the role as used by the present invention, and the mapping of the logical resources in the intersection to the appropriate OU-dependent physical resources;

FIGS. 4A-4C show a sample of the mapping process from logical to physical resources according to the inventive security model,

FIGS. 5A-5F shows the resource access control in a client-server architecture using the inventive security model;

FIG. 6 illustrates the interfaces of the inventive resource manager using the inventive security model; and

FIGS. 7A-7D shows a comparison between the administration steps of a prior art resource manager and the inventive resource manager.

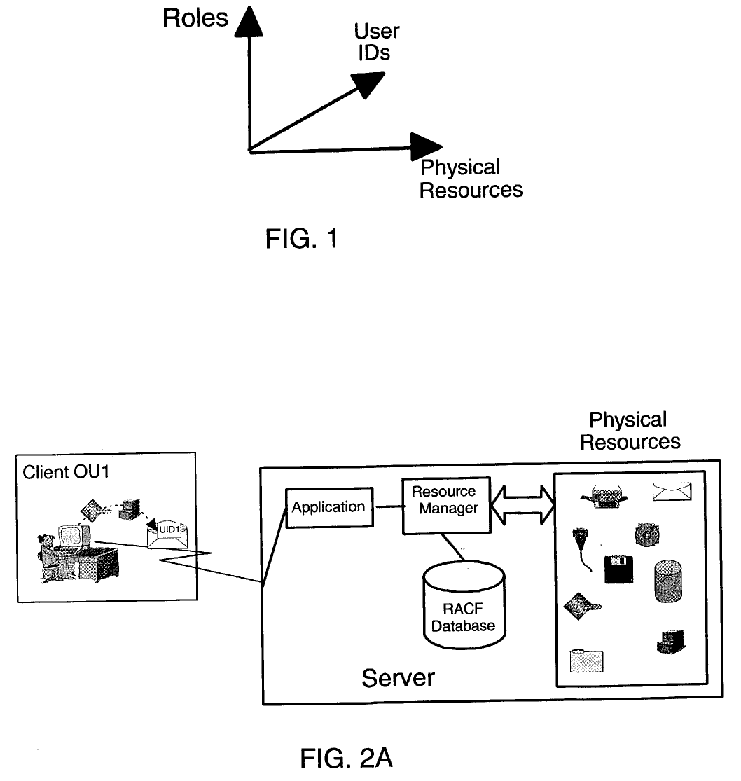

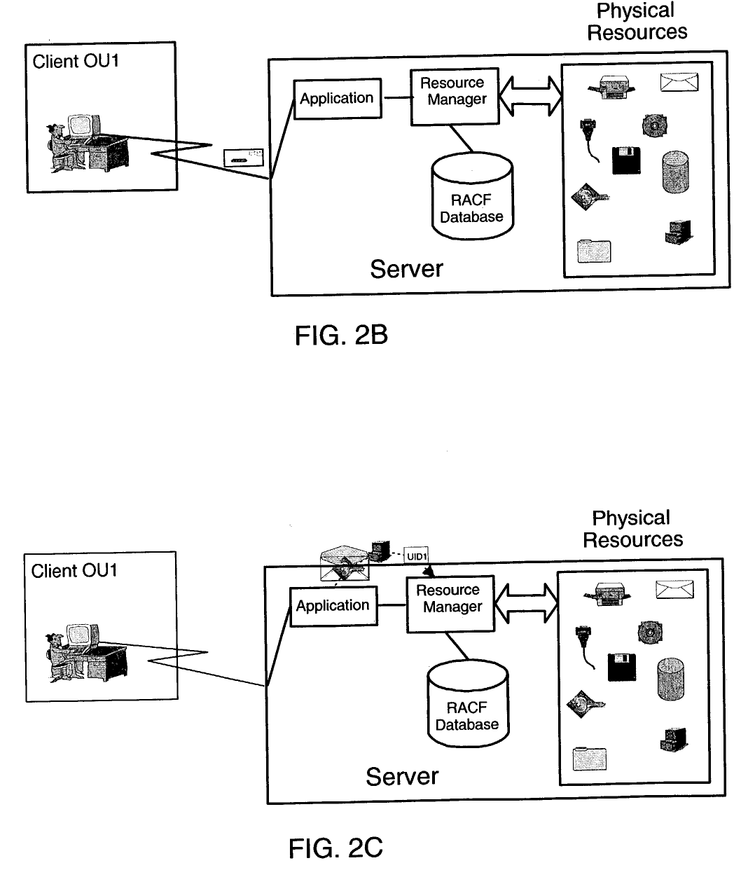

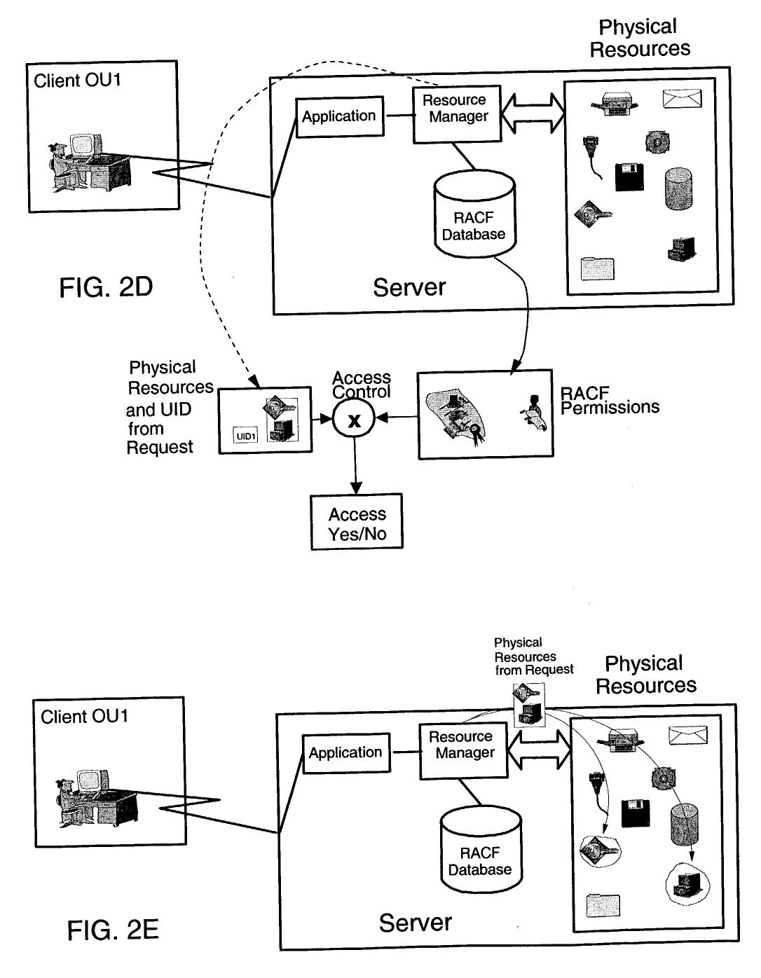

### DETAILED DESCRIPTION

The present invention is a five-dimensional resource and security model. The five dimensions are:

1. Logical Resources (LRs)

2. Physical Resources (PRs)

3. Organizational Units (OUs)

4. Roles (ROs)

5. Users and User Groups

The inventive security model is a combination of the three-dimensional resource model (dimension 1-3) and a three-dimensional security model (dimension 3-5) The common dimension between both models is the organizational unit (dimension 3).

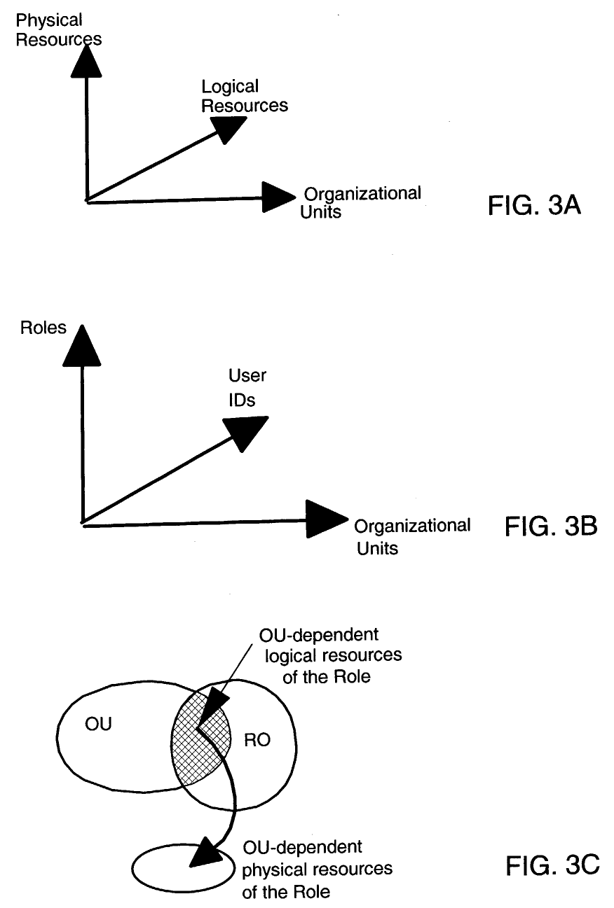

The three dimensions of the resource model are described below with reference to FIG. 3A.

A physical resource in general is defined as an object which may be used by an application for execution of a certain process, e.g. a signature key for authentication purposes, a printer for printing documents, a database table or a file for storing data, etc. Physical resources (PR) are the classical objects like queues, tables, communication links, printers, files as well as other objects like IDs, keys, commands, addresses, messages, message elements, etc.

Logical resources (LR) are an abstraction of physical resources, representing resources independent from the real world. Each LR is unique within the present invention and may be identified by its identifier, e.g. name. Further attributes can be used for specifying the purpose of a Logical Resource.

An organizational unit (OU) is defined by a set of logical resources, a set of physical resources and a function that maps a physical resource to a logical resource. OUs may be organized in a flat tree structure where the root of that tree is the system instance.

Each logical resource is assigned to or associated with a single physical resource for a given OU.

A three-dimensional security model illustrated in FIG. 3B is used to define role-based and OU-dependent access to logical resources for users.

Roles (ROs) are used to define a specific scope of functionality independent of any user and organizational unit, e.g. a role “secretary” or a role “manager” which cover the standard functions executed by secretaries or by managers (word processing, e-Mail, printing, encryption of documents). Roles are defined by a set of logical resources with “access attributes” or resource groups and can contain other roles and are applied by assigning a role in conjunction with an organizational unit to an user.

Because role definitions are independent of organization units, the actual scope of functionality of a role for a specific organization unit is determined at runtime by building the intersection between the sets of logical resources of the organizational unit and the role. Finally the physical resources allowed for that role in conjunction with that organizational unit are determined by applying the OU-specific transformation function to the logical resources of that intersection (see FIG. 3C). The abbreviation of a combination of a role RO and an OU is RO-OU.

A user in the invention is assigned one or more tuples [OU, RO]. The set of logical resources a user is allowed to access is the intersection of the logical resources of the role and the logical resources of the OU.

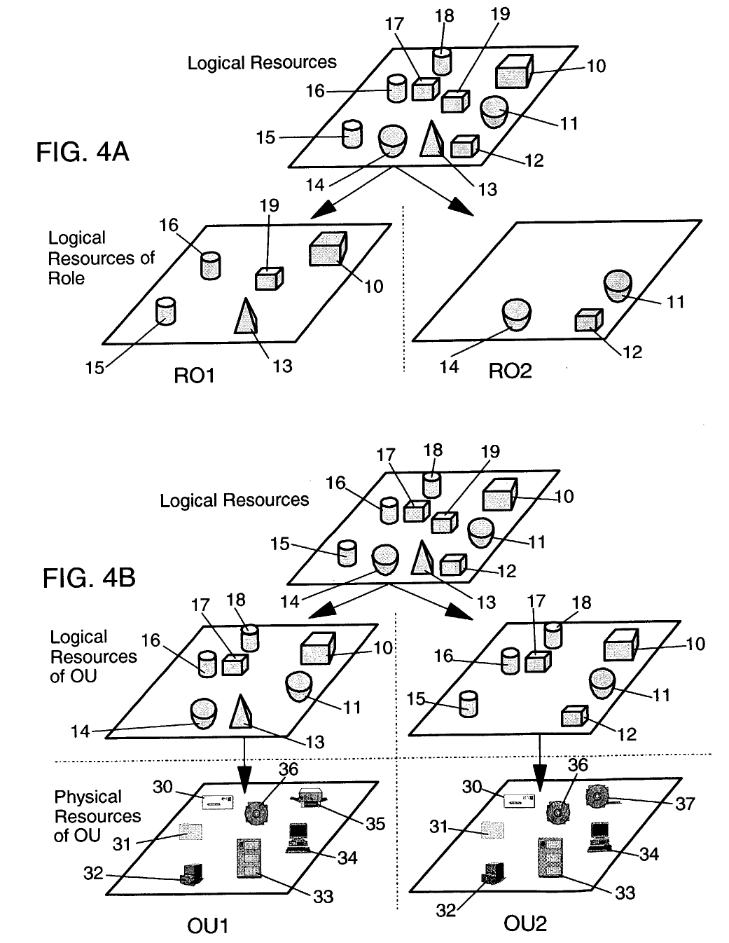

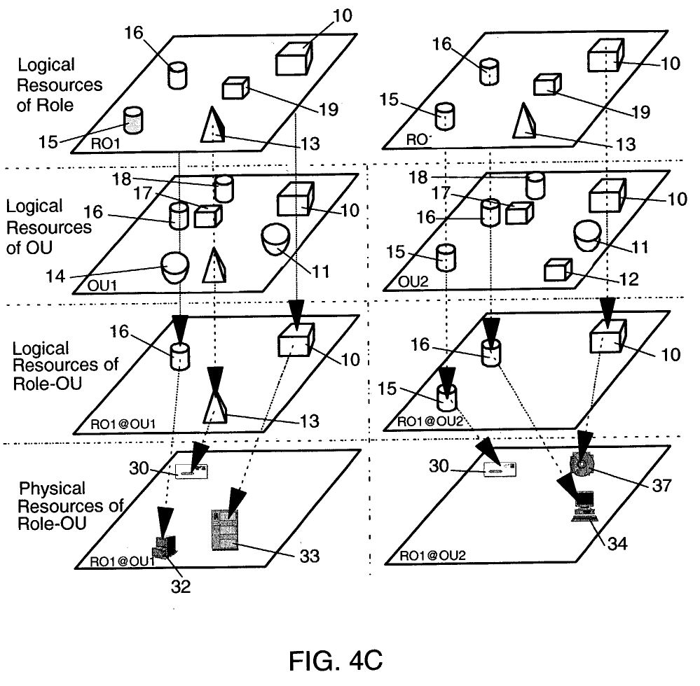

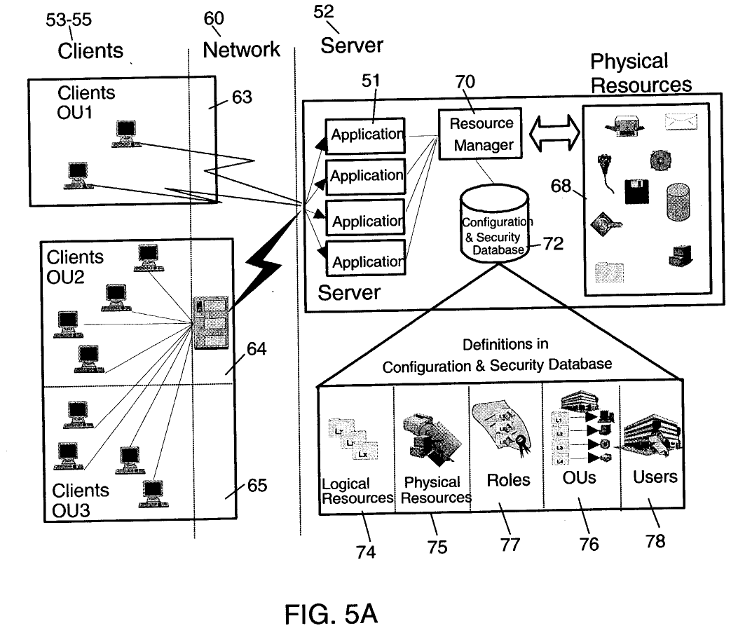

FIGS. 4A-4C illustrates the process of mapping logical to physical resources in accordance with the present invention. The system provides a role list for all defined logical resources 10-19 (see FIG. 4A). The role list is stored in a configuration database (not shown) and can be accessed by the resource manager. For example, user 1 is assigned RO1/OU1 and user 2 is assigned RO2/OU2. RO1 includes the logical resources 10, 13, 15, 16, 19 and R02 includes the logical resources 11, 12, 14.

A user list stored in the configuration database includes all registered users with their assigned roles and organization units OU. For example, user 1 is assigned organization unit 1 OU1 and user 2 is assigned organization unit 2 OU 2. Organization unit 1 OU1 is assigned the logical resources 10, 11, 13, 14, 16, 17, 18 and organization unit 2 OU2 is assigned the logical resources 10, 11, 12, 15, 16, 17, 18. Each of the logical resources assigned to OU1 and OU2 is associated with a specific physical resource (see FIG. 4B).

The physical resources which may be used by user 1 are determined by forming the intersection of the logical resources defined by the RO1/OU1 pair assigned to user 1 and OU1 or defined by the RO2/OU2 pair assigned to user 2 and OU2 and then mapping these logical resources to their associated physical resources. In the present example, user 1 who works for the OU 1 can use logical resources 10, 13, 16 and user 2 who works for OU 2 can use logical resources 10, 15, 16.

The logical resources 10, 13, 16 are associated with the physical resources 33, 30, 32 and the logical resources 10, 15, 16 are associated with the physical resources 37, 30, 34 (see FIG. 4C).

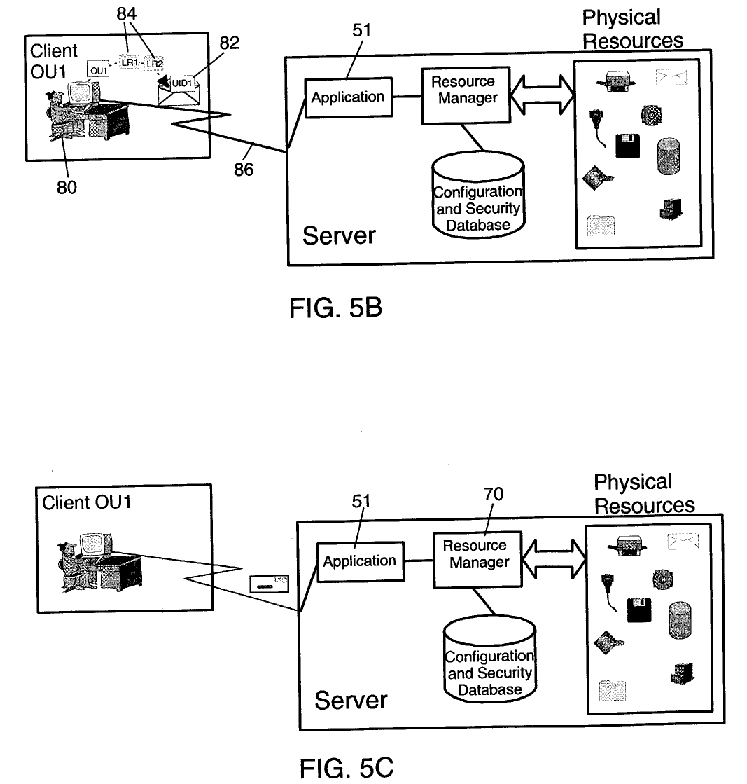

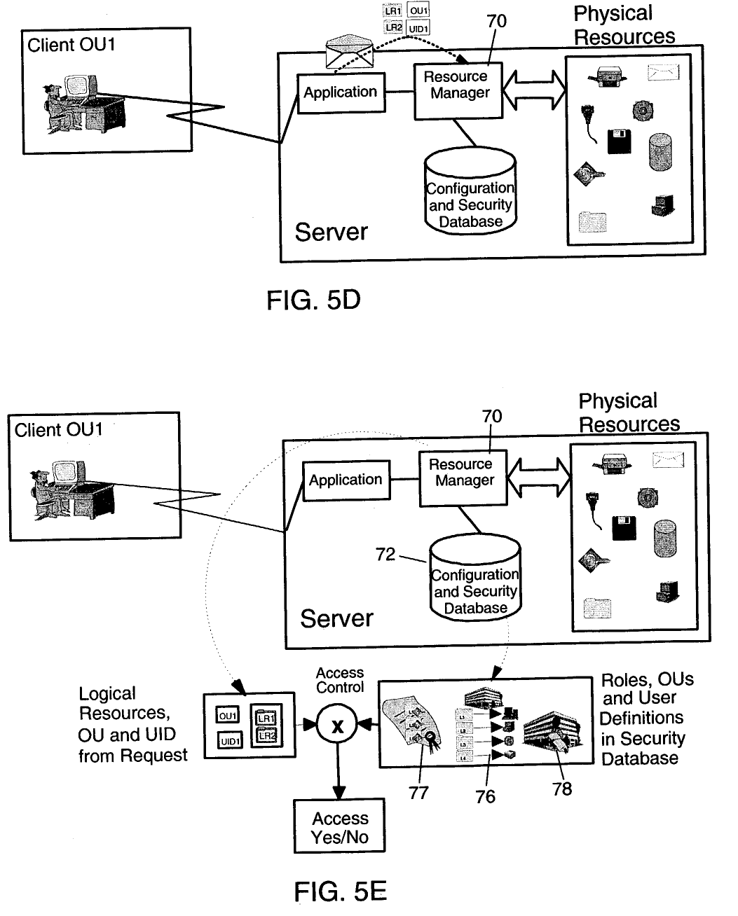

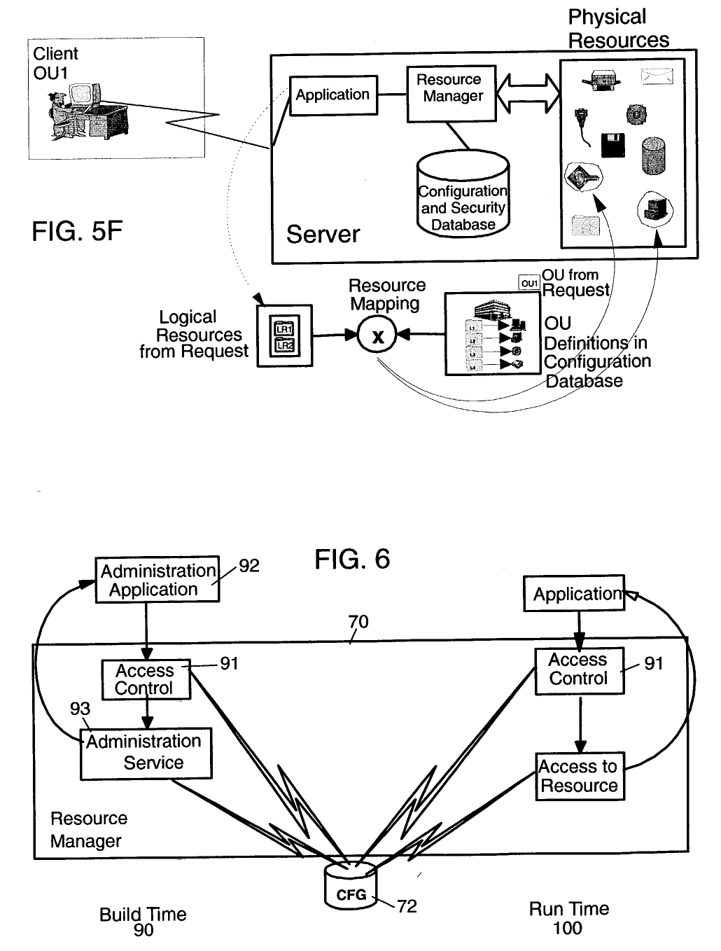

FIGS. 5A-5F show resource access control in a client-server architecture using the inventive security model.

Referring to FIG. 5A, several applications 51 are hosted on a server system 52. These applications 51 are used by several clients 53-55 connected via network 60 to the server 52 (either directly or via a proxy server). The clients 53-55 run on workstations 63-65 and send requests to the host applications 51 to perform specific processes. To perform the processes, the host applications 51 use resources 68 on the server system 52 (files, tables, keys, queues, communication links, etc.). The clients 53-55 are assigned to specific organizational units OU 1-3 (e.g. companies, departments in a company, functional areas in a department, etc.).

Resource manager 70 on the host system 52 controls access to the host resources by using definitions in its configuration and security database 72. The definitions in this database relate to the five dimensions of the invention; namely, logical resources 74, physical resources 75, organizational units 76, roles 77, and users 78.

Referring to FIG. 5B, a user 80 logs on to a host application 51 on the server system 52 by entering a user ID 82 and password and identifying the organizational unit he wants to work for (user ID=‘UID1’ and ‘OU1’). Then, the user sends a processing request to the host application 51. This request contains two logical resources 84 he wants to access (e.g. sign a message with a key ‘SIGN_KEY’ as LR1 and put it on a message queue ‘SEND_QUEUE’ as LR2). Referring to FIG. 5C, the request is sent via a network 86 to the connected host application. The network 86 may be LAN, Internet, or Intranet.

Referring to FIG. 5D, the host application 51 receives the request, retrieves the provided data, creates the appropriate requests and sends them on to resource manager 70. The resource manager 70 first checks the access rights for the requesting user ID and the organizational unit OU1 designated by the user. In doing that, the resource manager 70 uses the definitions of roles 77, organizational units 76, and users 78 stored in its configuration and security database 72.

Referring to FIG. 5E, the resource manager 70 checks whether the logical resources LR1, LR2 are already included in any RO-OU combination assigned to the requesting user ID. If any existing RO-OU combination contains the requested resources, access is permitted. See FIG. 5F.

FIG. 6 illustrates the interfaces of an access control system using the inventive security model in a client/server environment. The inventive resource manager 70 may be divided into a build time part 90 (administration) and a run time part 100. The build time part 90 comprises an access control component 91 allowing administration of the configuration data base 72. The configuration data are based on the inventive resource and security model as described earlier.

Access control component 90 of the build time part performs access control, analyzes the administration request, checks the request for consistency and routes it to the administration service. This administration service 93 performs the appropriate database operations and returns the result of the operation to the administration application 92. The run time part 100 uses the access control component 91 or access control to the requested Resources.

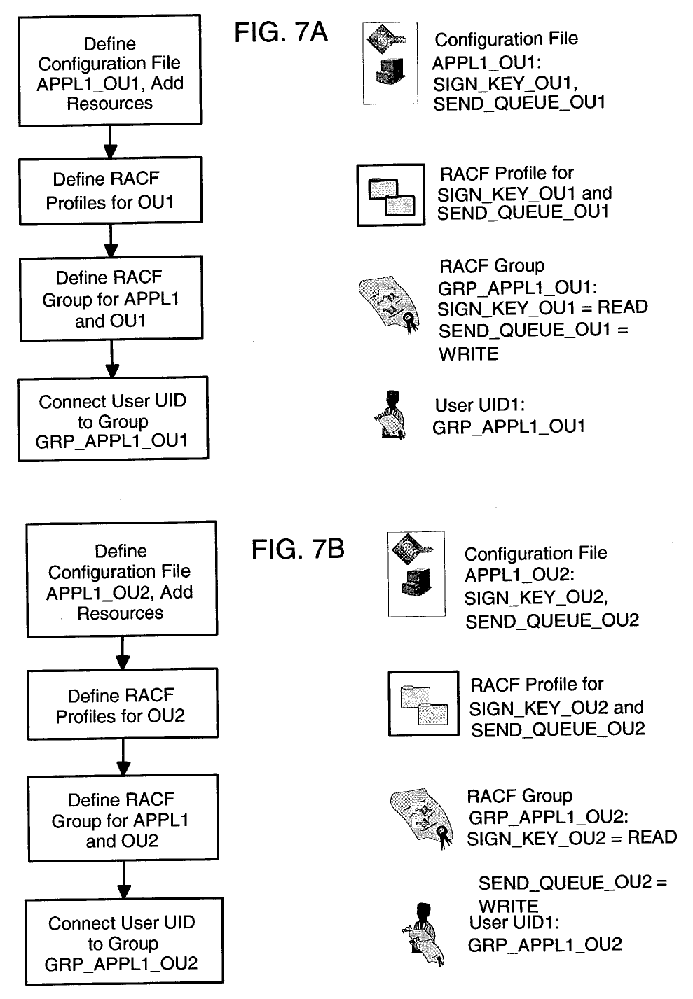

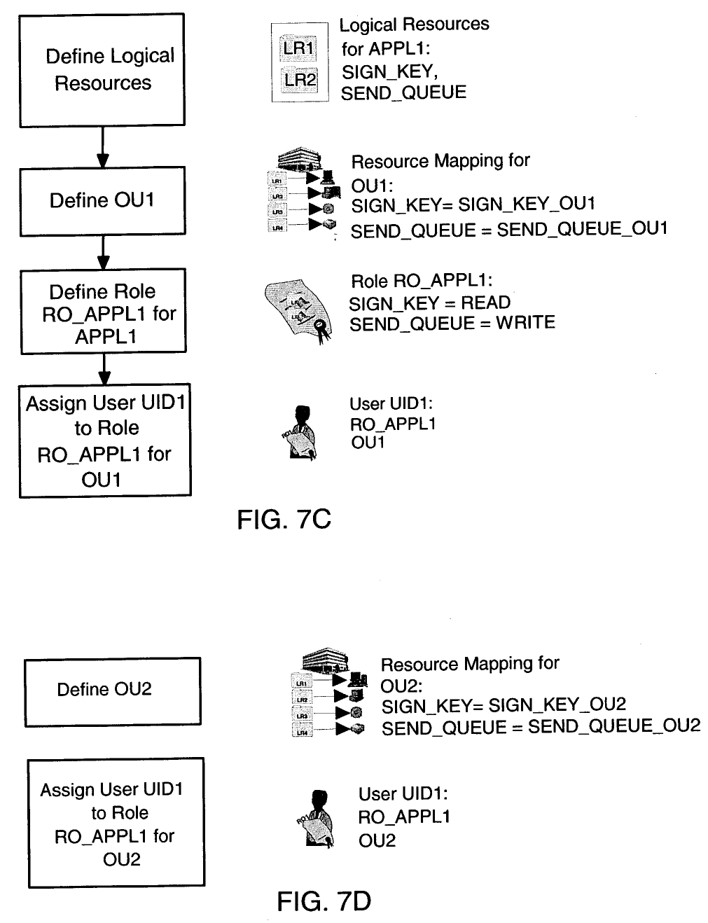

FIGS. 7A-7D illustrate the advantages of the invention over a known prior art resource manager RACF. FIGS. 7A and 7B show the steps performed by the prior art resource manager in defining a configuration file. FIGS. 7C and 7D show the steps performed by a system implementing the present invention in defining a configuration file.

The advantages of the present invention may be briefly summarized as follows: Support of client segregation regarding physical resources, system independent development and design of business processes and applications for multiple OUs, consistent relations between configuration and security data, easy administration by using resource and OU grouping, centralized configuration and security administration of all system resources for all applications using system resources, and changing physical resources without impact on security and applications.

What is claimed is:

1. A server system in a client-server environment having a data link to clients, at least one server application for processing accesses to physical resources (PR), a resource manager for controlling access to said physical resources, wherein said resource manager has access to a database which stores at least a set of physical resources (PRs), a list of users, a set of logical resources (LRs), a set of organization units (OUs), and a set of roles (ROs), and wherein access to said physical resources is granted by said resource manager when said physical resources are part of at least one set of mapped physical resources at the intersections between said set of logical resources of RO-OU pairs assigned to a specific user.

2. A server as claimed in claim 1 wherein said logical resources are abstractions of physical resources.

3. A server as claimed in claim 1 wherein said set of logical resources is organized in a tree-structure.

4. A server as claimed in claim 1 wherein each of said organization units represents a set of logical resources, a set of physical resources, and a function for mapping logical to physical resources.

5. A server as claimed in claim 1 wherein said set of organization units is organized in a tree-structure.

6. A server as claimed in claim 1 wherein each of said roles is assigned a set of logical resources.

7. A server as claimed in claim 6 wherein each logical resource assigned to a role is assigned access attributes.

8. A server as claimed in claim 1, wherein each user in said user list is assigned at least one RO-OU pair.

9. A server as claimed in claim 1 further comprising a set of administration roles, wherein each administration role defines a specific administration task being assigned to at least one administrator.

10. A server as claimed in claim 9 wherein said resource manager includes an interface for administration of data in said database and an interface for processing user requests for accessing physical resources by using said data in said database.

11. A server as claimed in claim 9 wherein said administration roles are unchangeable.

12. A method for accessing of physical resources in a server system having a data link to clients, at least one server application for processing accesses to physical resources, a resource manager for controlling access to said physical resources, wherein said resource manager has access to a database which stores at least a set of physical resources, a list of users, a set of logical resources, a set of organization units (OUs), and a set of roles, said method comprising the steps of:
receiving a request from a client system containing at least one user identifier, an OU-identifier and at least one logical resource identifier by said resource manager; determining the roles assigned to said user identifier for said OU;
forming the intersections between the logical resources of said OU and said roles;
mapping the logical resources contained in said request to the assigned physical resources of said OU contained in said request if each requested access to said logical resources is contained in at least one intersection; and
accessing said physical resource.

13. A method according to claim 12, wherein said a set of physical resources, said list of users, said set of logical resources, said set of organization units (OUs), and a set of roles are stored in tables or files in the database.

14. A method according claim 13, wherein said access to said physical resource can be accomplished either by the server application or by the resource manager.

15. A method for accessing physical resources by a server system having a data link to clients, at least one server application for processing accesses to physical resources, a resource manager for controlling access to physical resources, wherein said resource control manager has access to a database which stores at least a set of physical resources, a list of users, a set of logical resources, a set of organization units (OUs), and a set of roles, said method comprising the steps of:
receiving a request from a client system containing at least one user identifier, an OU-identifier, at least one logical resource identifier, and at least one physical resource identifier by said resource manager;
determining the roles assigned to said user identifier for said OU identifier;
forming the intersections between the logical resources of said OU and said determined roles;
mapping logical resourses within said intersections to assigned physical resources including access rights of said OU contained in said request; and
accessing said physical resources if each requested access to said physical resources contained in said request is contained in at least one intersection.
